(19) United States
(12) Patent Application Publication
(10) Pub. No.: US 2003/0117572 A1
(43) Pub. Date: Jun. 26, 2003

(54) Display device and its manufacture

(75) Inventors: Yasufumi Kanayama, Kawasaki (JP); Kiyoshi Ozaki, Kawasaki (JP); Makoto Morishige, Kawasaki (JP); Takeshi Umegaki, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU DISPLAY TECHNOLOGIES CORPORATION

(21) Appl. No.: 10/314,496

(22) Filed: Dec. 9, 2002

(30) Foreign Application Priority Data
Dec. 20, 2001 (JP) 2001-387960

(51) Int. Cl. G02F 1/1339

(52) U.S. Cl. 349/155

(57) ABSTRACT

A method of manufacturing a display device includes the steps of: (a) capturing an insulating granular spacer with an optical forceps apparatus which utilizes a capture force of a laser beam; (b) disposing the insulating granular spacer captured with the optical forceps apparatus on one of a pair of display device substrates at a predetermined position; and (c) stacking the pair of display device substrates via the insulating granular spacer. A display device is provided which can set the distance between a pair of display device substrates uniform and suppress the display quality from being lowered.

### CROSS REFERENCE TO RELATED APPLICATION

This application is based on Japanese Patent Application No. 2001-387960, filed on Dec. 20, 2001, the entire contents of which are incorporated herein by reference.

### BACKGROUND OF THE INVENTION

A) Field of the Invention

The present invention relates to a display device and its manufacture method, and more particularly to a display device having functional display elements disposed between a pair of opposing substrates.

As display devices of this kind, liquid crystal display devices, plasma display devices and the like are widely known. The following description will be made by taking as an example mainly a liquid crystal display device.

B) Description of the Related Art

A liquid crystal display device has a liquid crystal layer squeezed between a pair of opposing substrates having electrodes. A predetermined voltage is applied between electrodes to change the optical characteristics of the liquid crystal layer and display a desired image. In order to maintain the thickness of the liquid crystal layer uniform, granular spacers defining cell gaps are disposed between a pair of opposing substrates.

If granular spacers are distributed in the display area, orientations of liquid crystal molecules are disturbed and the display quality is lowered.

Techniques of preventing the display quality from being lowered are know which form spacer members in a non-display area. A thin film transistor substrate has a plurality of gate bus lines extending in one direction and a plurality of data bus lines extending in another direction crossing the one direction. A columnar spacer member of resin or the like is formed at each cross point between the gate bus line and data bus line. It is difficult, however, to form a spacer member having a uniform thickness and a flat surface at each cross point between the gate bus line and data bus line. Cell thickness defects are likely to occur. Irregular cell thicknesses result in a lowered display quality.

### SUMMARY OF THE INVENTION

An object of this invention is to provide a display device having a constant distance between a pair of substrates and suppressing the display quality from being lowered.

Another object of the invention is to provide a display device manufacturing method suitable for manufacturing such display devices.

According to one aspect of the present invention, there is provided a method of manufacturing a display device comprising steps of: (a) capturing an insulating granular spacer with an optical forceps apparatus which utilizes a capture force of a laser beam; (b) disposing the insulating granular spacer captured with the optical forceps apparatus on one of a pair of display device substrates at a predetermined position; and (c) stacking the pair of display device substrates via the insulating granular spacer.

According to another aspect of the invention, there is provided a display device comprising: a first-substrate having a plurality of pixel areas each including a display partition and including a pixel electrode and a pixel electrode driving element, and a crossed signal line group for transmitting signals for driving each pixel electrode driving element; a second substrate disposed facing the first substrate, the second substrate including a light transmitting area including a color filter and a light shielding area other than the light transmitting area, respectively corresponding to each display partition; a plurality of insulating granular spacers disposed between the first and second substrates and aligned generally with the light shielding area, the insulating granular spacers defining a distance between the first and second substrates; and a liquid crystal layer filled in a space between the first and second substrates.

According to another aspect of the invention, there is provided a method of manufacturing a liquid crystal display device with a step of dumping a foreign matter in a liquid crystal display panel, the panel comprising: a thin film transistor substrate including a first transparent substrate, a plurality of gate bus lines juxtaposed on the first transparent substrate, a plurality of data bus lines juxtaposed along a direction crossing the gate bus lines, a thin film transistor connected at each cross point between the gate bus line and data bus line, and a pixel electrode connected to each thin film transistor; an opposing substrate disposed facing the thin film transistor substrate, the opposing substrate including a second transparent substrate and a common electrode formed on the second transparent substrate; and a liquid crystal layer squeezed between the thin film transistor substrate and the opposing substrate, and the method comprising steps of: (a) capturing a foreign matter between the substrates by applying a capture laser beam to the foreign matter or destroying the foreign matter by applying a destruction laser beam to the foreign matter and thereafter capturing the destroyed foreign matter by applying the capture laser beam to the destroyed foreign matter; and (b) controlling a relative position between the capture laser beam and the liquid crystal display panel and dumping the captured foreign matter in a collection area other than a predetermined area.

According to another aspect of the invention, there is provided a liquid crystal display device comprising: a thin film transistor substrate including a first transparent substrate formed with a plurality of gate bus lines juxtaposed on the first transparent substrate, a plurality of data bus lines juxtaposed along a direction crossing the gate bus lines, a thin film transistor connected at each cross point between the gate bus line and data bus line, and a pixel electrode connected to each thin film transistor; an opposing substrate disposed facing the thin film transistor substrate, the opposing substrate including a second transparent substrate formed with a common electrode; a liquid crystal layer squeezed between the thin film transistor substrate and the opposing substrate; and a foreign matter collected in a collection area other than a predetermined area in a space between the thin film transistor substrate and the opposing substrate.

According to another aspect of the invention, there is provided a liquid crystal display device comprising: a thin film transistor substrate including a first transparent substrate formed with a plurality of gate bus lines juxtaposed on the first transparent substrate, a plurality of data bus lines juxtaposed along a direction crossing the gate bus lines, a thin film transistor connected at each cross point between the gate bus line and data bus line, a transparent pixel electrode connected to each thin film transistor and including a display partition, and a storage capacitor electrode facing each transparent pixel electrode via an insulating layer and extending along each transparent pixel electrode; a color filter substrate disposed facing the thin film transistor substrate, the color filter substrate including a second transparent substrate formed with a light shielding film defining an area corresponding to each display partition, a light transmitting area defined by the light shielding film, corresponding to each display partition and including a color filter, and a common transparent electrode disposed on the color filters; and a plurality of extended spacer members extending above ones of the gate bus lines, data bus lines and storage capacitor electrodes along an extension direction of the ones, the extended spacer members defining a distance between the thin film transistor substrate and the color filter substrate.

According to another aspect of the invention, there is provided a method of manufacturing a liquid crystal display device comprising steps of: (a) manufacturing a first substrate including a first transparent substrate formed with a plurality of gate bus lines juxtaposed on the first transparent substrate, a plurality of data bus lines juxtaposed along a direction crossing the gate bus lines, a thin film transistor connected at each cross point between the gate bus line and data bus line, a transparent pixel electrode connected to each thin film transistor and including a display partition, and a storage capacitor electrode facing each transparent pixel electrode via an insulating layer and extending along each transparent pixel electrode; (b) manufacturing a second substrate including a second transparent substrate formed with a light shielding film defining an area corresponding to each display partition, a light transmitting area defined by the light shielding film, corresponding to each display partition and including a color filter, a common transparent electrode disposed on the color filters, and a plurality of extended spacer members extending above ones of the gate bus lines, data bus lines and storage capacitor electrodes along an extension direction of the ones, the extended spacer member being disposed superposed upon the light shielding film and including a lamination of a plurality of layers made of the same layers as the color filters and another resin layer; and (c) disposing the first and second substrates facing each other via the plurality of extended spacer members.

According to another aspect of the invention, there is provided a method of manufacturing a liquid crystal display device comprising steps of: (a) manufacturing a first substrate including a first transparent substrate formed with plurality of gate bus lines juxtaposed on the first transparent substrate, a plurality of data bus lines juxtaposed along a direction crossing the gate bus lines, a thin film transistor connected at each cross point between the gate bus line and data bus line, a transparent pixel electrode connected to each thin film transistor and including a display partition, a storage capacitor electrode facing each transparent pixel electrode via an insulating layer and extending along each transparent pixel electrode, and a plurality of extended spacer members extending above ones of the gate bus lines, data bus lines and storage capacitor electrodes along an extension direction of the ones; (b) manufacturing a second substrate including a second transparent substrate formed with a light shielding film defining an area corresponding to each display partition, a light transmitting area defined by the light shielding film, corresponding to each display partition and including a color filter, and a common transparent electrode disposed on the color filters; and (c) disposing the first and second substrates facing each other via the plurality of extended spacer members.

With such arrangements, a display device easy to maintain the distance between a pair of substrates uniform can be provided.

### BRIEF DESCRIPTION OF THE DRAWINGS

FIGS. 1A to 1C are schematic cross sectional views and a perspective view showing the structure of an optical forceps apparatus used by embodiments of the invention.

FIGS. 2A to 2C are schematic cross sectional views illustrating processes of a liquid crystal display manufacturing method according to an embodiment.

FIGS. 3A to 3C are schematic cross sectional views and a plan view showing the structure of a display device manufactured by the embodiment method.

FIG. 4 is schematic cross sectional views illustrating processes of a liquid crystal display manufacturing method according to another embodiment.

FIGS. 5A to 5C are perspective views briefly illustrating the processes of the embodiment method illustrated in FIG. 4.

FIGS. 6A and 6B are perspective views briefly illustrating processes of a liquid crystal display device manufacturing method according to another embodiment of the invention.

FIG. 7 is a plan view showing another embodiment of the invention.

FIGS. 8A to 8C are a schematic plan view and cross sectional views showing the structure of a liquid crystal display device according to another embodiment of the invention.

FIGS. 9A to 9C are a plan view and cross sectional views showing the outline structure of a liquid crystal display device according to another embodiment of the invention.

FIG. 10 is a plan view briefly showing a modification of the embodiment.

FIG. 11 is a plan view briefly showing a modification of the embodiment.

FIGS. 12A to 12C are plan views and a cross sectional view showing the outline structure of a liquid crystal display device previously proposed in the specification submitted by the present applicant.

### DESCRIPTION OF THE PREFERRED EMBODIMENTS

In a conventional liquid crystal display device, granular spacers for maintaining the cell gaps constant are dispersed on one substrate and the other substrate is superposed thereon. These dispersed granular spacers are difficult to distribute only in the non-display area, but disposed randomly also in the display area. The orientation of liquid crystal molecules contacting the spacer surface is disturbed. The spacers in the display area lower the display quality. If granular spacers can be distributed only in the non-display area, it is possible to prevent the display quality from being lowered.

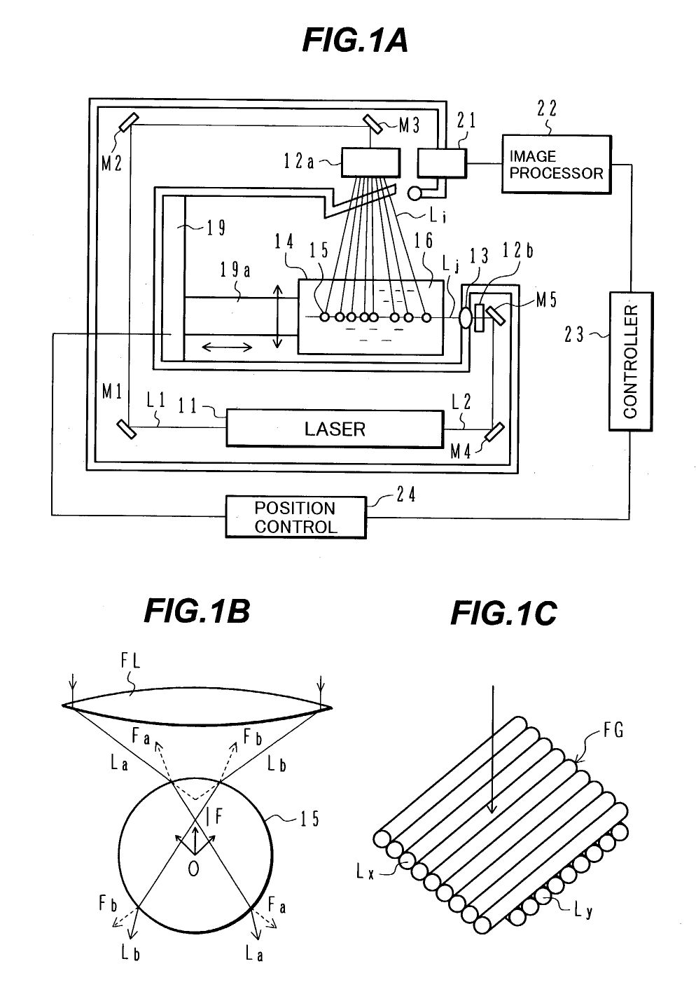

FIGS. 1A to 1C, FIGS. 2A to 2C and FIGS. 3A to 3C are schematic cross sectional views, perspective views and a plan view illustrating a method of manufacturing a display device according to an embodiment of the invention.

FIG. 1A schematically shows the structure of an optical forceps apparatus which is used to grip a granular spacer and plant it at a desired position of a substrate. A laser source 11 is, for example, an yttrium aluminum garnet (YAG) laser source for irradiating continuous light having a wavelength of 1.06 μm. The laser source 11 irradiates laser beams L1 and L2 from the front and back faces. The laser beam L1 is reflected by mirrors M1, M2 and M3 and becomes incident upon a laser splitter 12a. The laser splitter 12a splits one incidence laser beam into a plurality of desired laser beams L1 at desired positions.

A vessel 14 filled with liquid 16 is disposed in front of the laser splitter 12a. A number of granular spacers 15 are contained in the liquid 16. For example, the granular spacer 15 is a spherical glass bead or plastic bead made of transparent insulating material and having a diameter of 1 μm to 10 μm. Instead of a spherical bead, other beads such as an ellipsoidal bead and a cylindrical bead may be used.

It is the requisite that the liquid 16 has a refraction factor different from that of the granular spacer 15 and the surface of the granular spacer 15 forms an optical interface. Although the liquid 16 is not necessarily required, in order to uniformly distribute granular spacers in a limited space, it is desired to use liquid in which granular spacers float.

FIG. 1B is a schematic diagram illustrating an optical forceps instrument. A laser beam entered a lens FL becomes a converged laser beam. Light beams La and Lb shown in FIG. 1B enter a granular spacer 15 and are refracted at the surface of the spacer. As the light beams La and Lb are refracted, their momentums change. Forces Fa, Fb and the like are generated through action and reaction by the law of conservation of momentum. These forces Fa and Fb are external forces applied to the granular spacer 15. If an external force F, which is an integration of all laser beams incident upon the granular spacer, balances or becomes greater than the gravitational force of the granular spacer 15, then the granular spacer 15 is supported or lifted. If the relative position between the light flux and granular spacer changes, a generated force also changes. In this manner, an optical forceps instrument can be realized which can grip a fine particle by using light.

In the structure shown in FIG. 1A, a plurality of laser beams L1 are irradiated in desired directions and capture granular spacers 15 with the laser beams.

FIG. 1C shows an example of the structure of an optical element for generating a plurality of laser beams. As shown, an optical fiber grating FG is made of a combination of a plurality of cylindrical lenses Lx juxtaposed in an x-direction and a plurality of cylindrical lenses Ly juxtaposed in a y-direction. A plurality of lenses are formed at cross points between the cylindrical lenses Lx and Ly. Light beams are converged by these lenses having uniform focal distances. In this manner, split laser beams can be generated on a two-dimensional plane at convergence points having a desired pitch. For example, a laser beam group having convergence points of a two-dimensional matrix shape can be generated.

In the structure shown in FIG. 1A, the laser beam L2 is reflected by mirrors M4 and M5 and irradiated into the liquid 16 via a laser splitter 12b and a lens 13. The lens 13 converges each light beam Lj. The laser splitter 12b has the structure similar to that of the laser splitter 12a. The lens 13 may be omitted or a lens may be combined with the laser splitter 12a.

If the laser beams Li and Lj are arranged to cross in the liquid 16, the granular spacer 15 can be captured at the cross point with the priority over other cross points.

The vessel 14 filled with the liquid 16 which contains the granular spacers 15 is supported by arms 19a which are moved by a feed mechanism 19.

An image pickup apparatus 21 monitors the granular spacers 15 in the vessel 14 and generates image signals of the granular spacers 15. An output signal from the image pickup apparatus 21 is processed by an image processor 22, and analyzed by a controller 23 to acquire information of the granular spacer 15 and laser beams Li and Lj. In accordance with this information, a control signal is supplied from the controller 23 to a position controller 24. The position controller 24 controls the feed mechanism 19 to control the position of the vessel 14. As will be described hereinunder, the feed mechanism 19 is provided with other arms.

The granular spacers 15 are distributed randomly in the liquid 16. In order to make each laser beam Li reliably capture the granular spacer, it is desired that the granular spacer existing in a predetermined area can be captured reliably by the laser beam by scanning the arms 19a. Although the laser beam convergence points are disposed in a two-dimensional plane, a plurality of laser beam convergence points distributed in a one-dimensional space may be disposed. Obviously, only a single laser beam may be used.

After the laser beam Li captures a granular spacer, the arms 19a are lowered to pick up the granular spacer 15 out of the liquid 16.

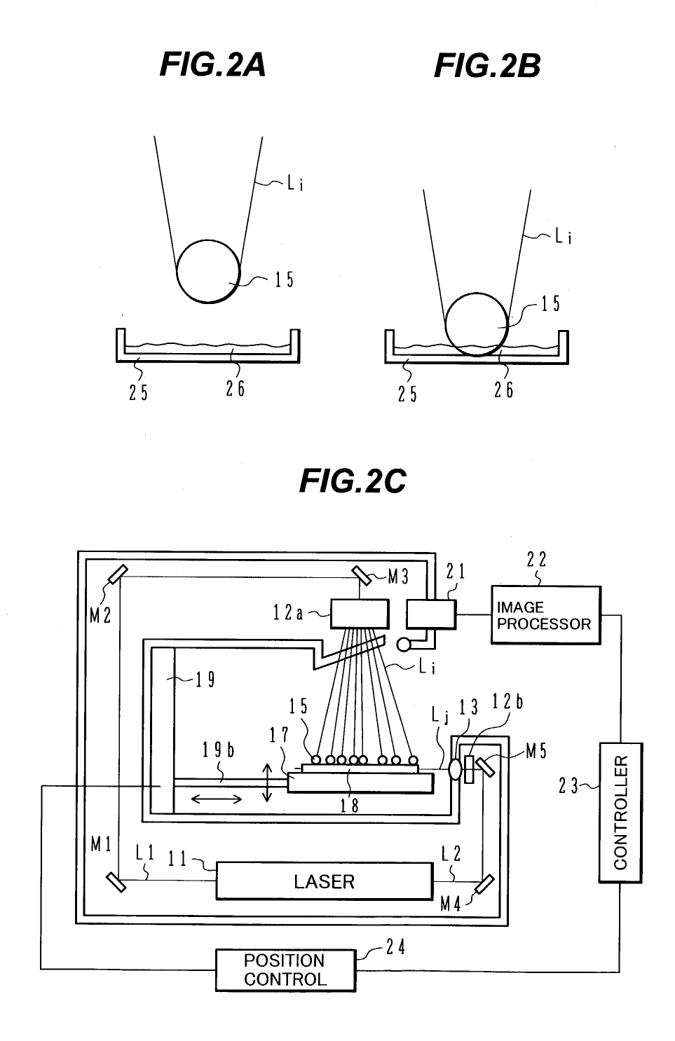

As shown in FIG. 2A, the granular spacer 15 captured by the laser beam Li is moved to the area above a vessel 25 accommodating UV hardening resin 26. After the granular spacer 15 reaches the area above the UV hardening resin 26, as shown in FIG. 2B the distance between the laser beam Li and vessel 25 is shortened to immerse the lower surface of the granular spacer 15 into the UV hardening resin 26. In this manner, the UV hardening resin can be coated on the lower surface of the granular spacer 15. The UV hardening resin is preferably coated on about one third of the lower surface of the granular spacer 15.

As shown in FIG. 2C, a stage 17 held by other arms 19b is moved to the area under the beam splitter 12a. A color filter substrate 18 is being placed on the stage 17. By shortening the distance between the laser beam Li and color filter substrate 18, it is possible to place the granular spacer 15 captured by the laser beam Li on the color filter substrate 18 at a desired position.

By setting beforehand the position of each laser beam Li, the granular spacer 15 can be mounted on the color filter substrate 18 at a desired position, e.g., on a light shielding film at a position corresponding to a storage capacitor electrode or a thin film transistor. Thereafter, a ultraviolet ray is applied to the UV hardening resin coated on the lower surface of the granular spacer 15 disposed on the color filter substrate 18 to harden the UV hardening resin and fix the granular spacer 15 to the surface of the color filter substrate 18. Adhesive other than the UV hardening resin may be used.

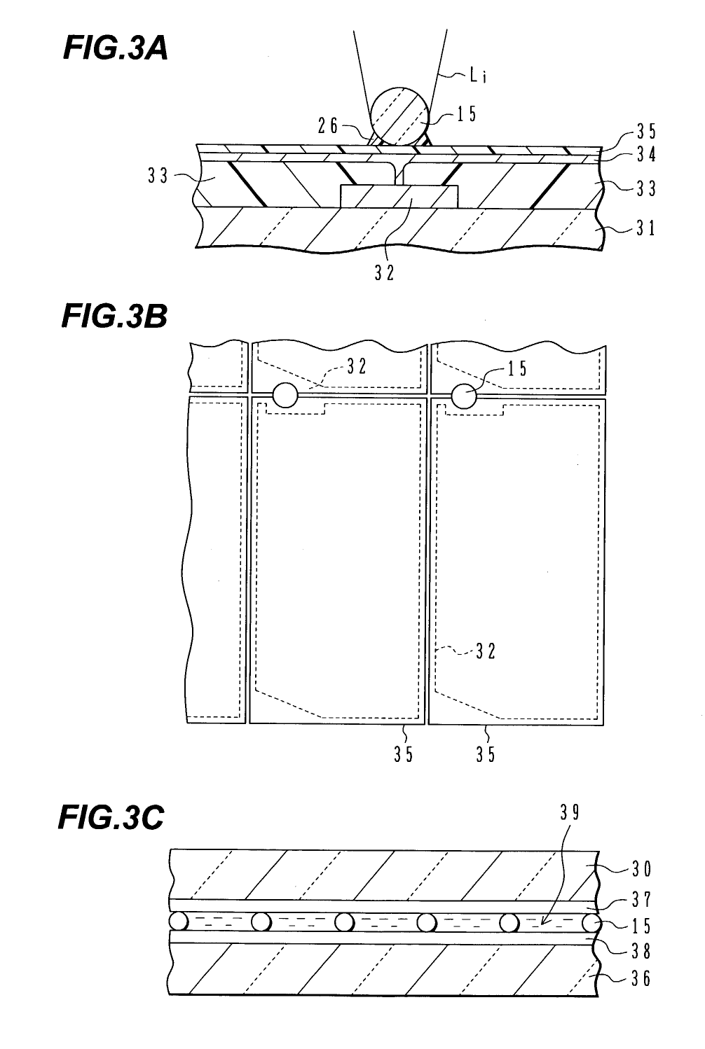

FIG. 3A is a schematic diagram showing the structure of a granular spacer disposed on the color filter substrate. The color filer substrate has a light shielding film 32 formed on the surface of a transparent glass substrate 31. The light shielding film 32 is made of, for example, a metal layer of Cr and forms a black matrix of the light shielding area. A resin color filter 33 is formed on the light shielding film. The color filter 33 not superposed upon the light shielding film 32 forms a light transmission area through which light of a desired chromatic color passes.

On the surface of the color filter 33, a transparent electrode 34 made of indium tin oxide (ITO) or the like is formed. On the surface of the transparent electrode 34, an alignment film 35 is formed. For example, if a vertical alignment film is used as the alignment film 35, rubbing can be omitted. Obviously, the alignment film 35 may be rubbed to form a horizontal alignment film.

A granular spacer 15 is disposed on the alignment film 35, and UV hardening resin 26 is inserted between the granular spacer 15 and alignment film 35. Although one granular spacer 15 captured by one light beam Li is shown, a number of granular spacers 15 can be disposed at the same time at desired positions.

FIG. 3B is a plan view briefly showing the structure of a color filter substrate. On the glass substrate, a black matrix 32 is formed by the light shielding film, covering the gate bus lines, data bus lines and thin film transistors. Color filters 35 are formed partially overlapping the light shielding film 32. The color filters 35 have predetermined colors of red (R), green (G) and blue (B). In the structure shown in FIG. 3B, the granular spacer 15 is disposed above a thin film transistor.

Since the granular spacer 15 can be disposed in a predetermined area of each pixel area of the liquid crystal display device, the cell gaps can be maintained uniform. Since the granular spacer is not disposed in the display area, the display quality of the display area can be suppressed from being degraded.

Even if the granular spacer is tried to be disposed only above the light shielding area, some granular spacers may be disposed outside the light shielding area. Also in such a case, granular spacers disposed by an optical forceps apparatus as a whole are mostly disposed in the light shielding area so that the display quality can be prevented from being lowered. Granular spacers “generally” aligned with the light shielding area are intended to include such a case.

FIG. 3C is a schematic cross sectional view of a display device. A pair of substrates 30 and 36 is disposed opposing each other, and a functional medium 39 is accommodated therebetween. Functional layers 37 and 38 are formed on the surfaces of the substrates 30 and 36 and granular spacers 15 are disposed in a predetermined layout between the functional layers 37 and 38.

In the case of a liquid crystal display device, the functional medium 39 is a liquid crystal layer, the functional layer 37 includes, for example, color filters, light shielding film and transparent electrodes, and the function layer 38 includes bus lines, thin film transistors, pixel electrodes and storage capacitors.

In the case of a plasma display device, the medium 39 is vacuum, the functional layer 37 is a fluorescent layer, and the functional layer 38 is a plasma generator.

The granular spacer 15 may use various spacers of a sphere shape, a cylindrical shape, an ellipsoid shape and the like. If a spherical granular spacer is used, it is easy to dispose granular spacers in such a manner that the distance between substrates is maintained uniform.

Some foreign matters may be found after the manufacture of a liquid crystal display device. Such foreign matters may degrade the display quality. Conventionally, such foreign matters are destroyed by applying a laser beam thereto, or the substrates are pressed from both sides of a foreign matter to crash it. Even if a foreign matter is destroyed or crashed, the foreign matter still exists in a different shape and the display quality is lowered in many cases. If the substrates are damaged when a foreign matter is crashed, the display quality is degraded.

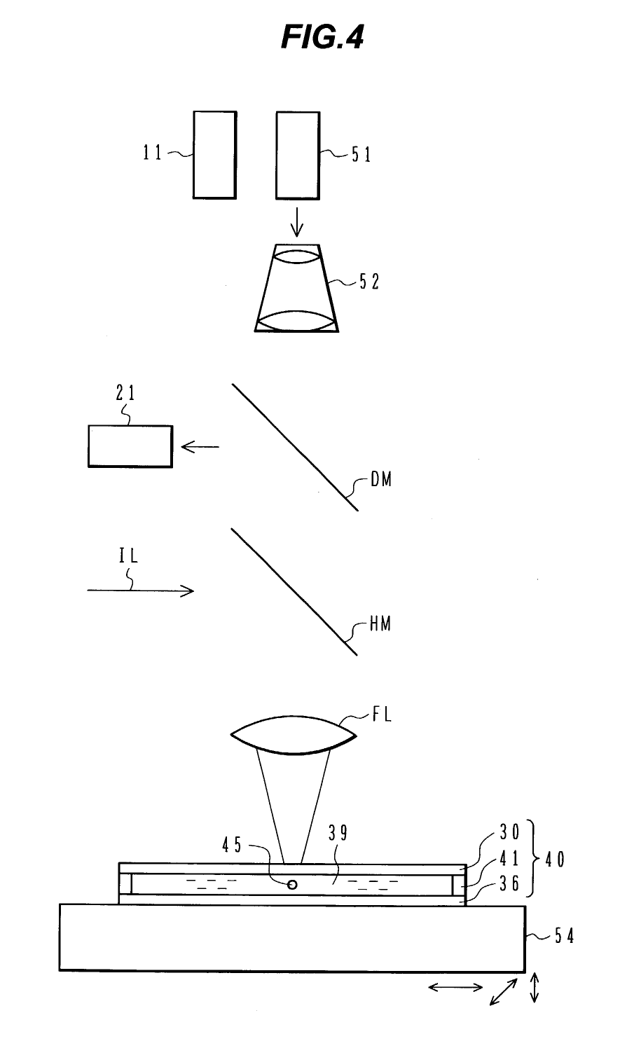

FIG. 4 schematically shows the structure of a system for removing a foreign matter in a liquid crystal display device. A liquid crystal display device 40 is being placed on a stage 54. The liquid crystal display device 40 has a liquid crystal layer 39 squeezed between a pair of substrates 30 and 36 and the space between the substrates is sealed with a sealing member 41.

The stage 54 is controlled to be movable in x-, y- and z-directions.

Above the stage 54, a lens FL, a half mirror HM and a dichroic mirror DM are disposed. Above these optical components, a beam expander 52 is disposed. Above the beam expander 52, two types of laser sources 11 and 51 are disposed which can be used in an exchangeable manner. The laser source 11 is a continuous oscillation laser for optical forceps, and the laser source 51 is a high output laser for foreign matter destruction. The laser may be a YAG laser, a semiconductor laser and the like.

An illumination system for applying illumination light IL is disposed at the side of the half mirror HM, and an image pickup system 21 is disposed at the side of the dichroic mirror DM. An image in the liquid crystal display 40 illuminated with the illumination light IL is reflected by the dichroic mirror DM so that it can be monitored with the image pickup system 21.

The liquid crystal display device 40 is disposed with the color filter substrate 30 directed upward. The light shielding film of the color filter substrate is preferably made of a resin layer which shields visible light and transmits light of a desired wavelength. The illumination light IL has preferably a wavelength in the transmission range of the resist layer so that the image pickup system 21 can detect the illumination light IL having such a wavelength.

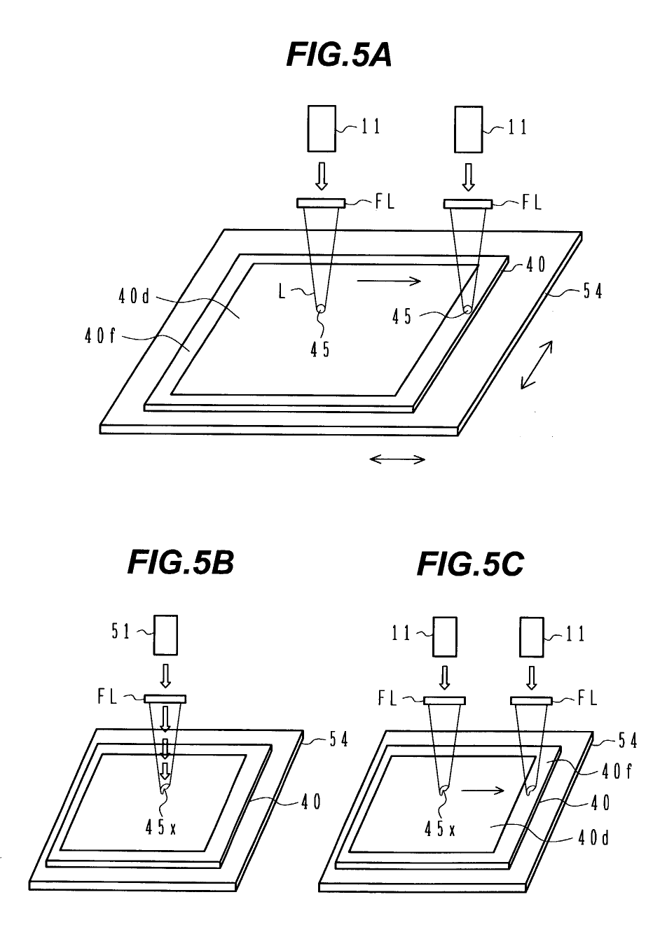

FIG. 5A illustrates a method of moving a foreign matter found in a liquid crystal layer to an area where the foreign matter will not degrade the display quality. A liquid crystal display device 40 has a display area 40d and a non-display area 40f having a light shielding film. The non-display area 40f is a so-called frame area which is formed in the outer peripheral area of the display area 40d and does not affect the display quality. A foreign matter 45 exists in the liquid layer in the display area 40d.

The laser source 11 for optical forceps is disposed above the expander 52. A laser beam L is passed through the lens FL to converge it upon the foreign matter 45. After the foreign matter 45 is captured by the laser beam L, the relative distance between the laser source 11 and stage 54 is controlled to move the foreign matter 45 to the non-display area 40f of the liquid crystal display device 40. When the foreign matter 45 is moved to the non-display area 40f, the optical forceps function is stopped to make the foreign matter 45 resident in the non-display area 40f.

FIGS. 5B and 5C illustrate a method of moving a foreign matter 45x attached to the substrate of a liquid crystal display device 40.

As shown in FIG. 5B, by using the laser source 51 for destruction, a laser beam is passed through the lens FL and the converged beam is applied to a foreign matter 45x to destroy it. The foreign matter 45x attached to the substrate is released from the substrate and distributed as foreign matter pieces.

As shown in FIG. 5C, by using the laser source 11 for optical forceps, a laser beam is passed through the lens FL to apply a converged beam to the destroyed foreign matter pieces 45x. By controlling the relative position between the laser source 11 and stage 54, the foreign matter pieces 45x are moved to the non-display area 40f.

By utilizing the optical forceps function or the optical destruction function and optical forceps function, foreign matters found in an assembled liquid crystal display device can be dealt with without damaging the display quality.

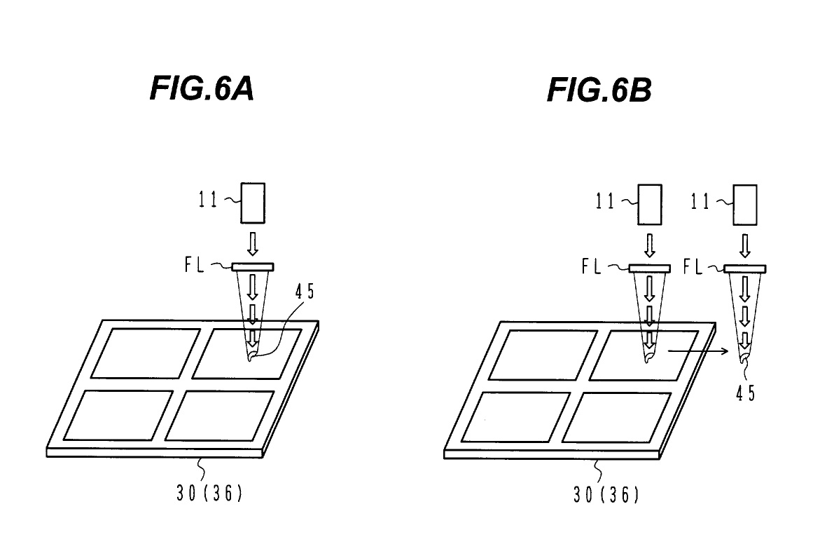

FIGS. 6A and 6B illustrate a method of removing a foreign matter existing on a display device substrate before assembly. As shown in FIG. 6A, a laser beam from the laser source 11 is irradiated via the lens FL to a foreign matter 45 found on the display device substrate 30 (36) to capture the foreign matter 45 by utilizing the optical forceps function.

As shown in FIG. 6B, by controlling the relative position between the optical forceps and substrate, the foreign matter 45 is moved outside the substrate and dumped.

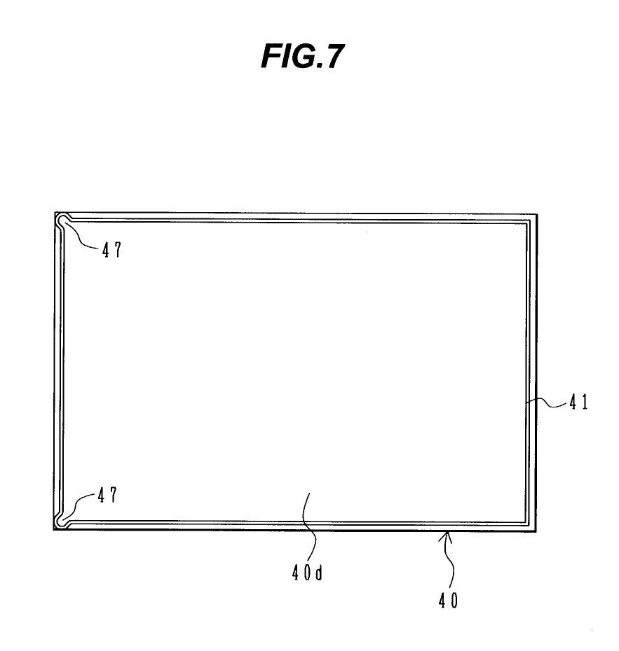

FIG. 7 shows the structure of a liquid crystal display device with a reduced non-display area or with a disappeared so-called frame area. A sealing member 41 is disposed near at the outer periphery of a liquid crystal display device 40. Almost the whole area inside the sealing member 41 is the display area 40d. The shape of the sealing member 41 is devised to form a detracted foreign matter collection area (dumping area) 47. The collection area 47 is formed outside the display area and in this context it is the non-display area. With this arrangement, even if the frame area does not exist, foreign matters in the liquid crystal layer can be collected in the collection area (dumping area) so that the influence upon the display quality can be suppressed as much as possible.

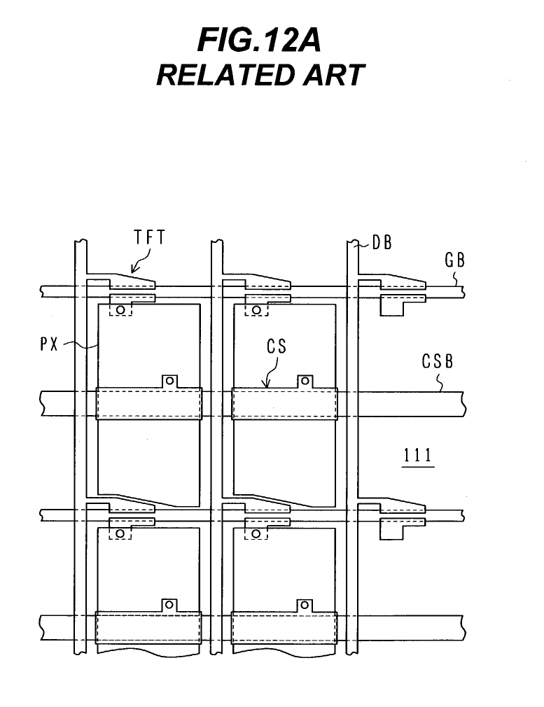

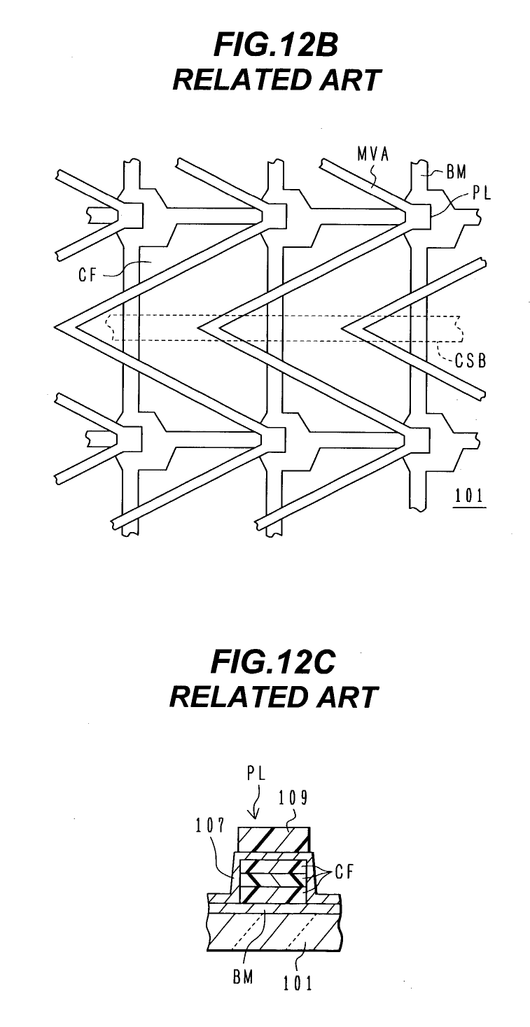

FIGS. 12A to 12C are schematic plan views and a schematic cross sectional view showing the structure of spacer members disposed on a substrate as previously proposed in the specification submitted by the present applicant. FIG. 12A is a plan view of a thin film transistor substrate, and FIG. 12B is a plan view of a color filter substrate. FIG. 12C is a schematic cross sectional view showing a columnar spacer member.

As shown in FIG. 12A, in the thin film transistor substrate, a patterned Cr film of gate bus lines GB is formed on the surface of a glass substrate 111. After the patterned Cr film is covered with the gate insulating film, data bus lines DB and thin film transistors TFT are formed by a lamination film of semiconductor layers and metal layers. After TFT's are formed, a protective film is formed on the surface of the substrate. After contact holes are formed through the protective layer, pixel electrodes PX of ITO or the like are formed. Thereafter, an alignment film is formed on the surface of the substrate to complete the thin film transistor substrate.

At the same time when the gate bus lines GB are formed, a storage capacitor electrode CSB is formed in an area superposing upon the pixel electrode PX. At the same time when the drain bus lines DB are formed, an intermediate conductive layer is formed above the storage capacitor electrode CSB. The intermediate conductive layer is covered with a protective film and then with a transparent electrode PX. In this manner, a storage capacitor CS is formed.

FIG. 12B shows the structure of the color filter substrate to be used in combination with the thin film transistor substrate shown in FIG. 12A. On the surface of a glass substrate 101, a black matrix BM of a Cr film or the like is formed. The black matrix BM covers the thin film transistor TFT area as well as the areas corresponding to the gate bus lines GB and drain bus lines DB to define the display area.

In the opening area defined by the black matrix BM, color filters CF are formed. Transparent electrodes are formed covering the color filters CF. In the structure shown in FIG. 12B, a projection MVA made of resin or the like for forming multi domains is formed on the transparent electrode. An alignment film is formed on the projection MVA. The projection MVA constitutes a columnar member PL which is used for forming a columnar spacer member in a cross area between the gate bus line GB and drain bus line DB.

FIG. 12C schematically shows the structure of the columnar member PL. The black matrix BM is disposed on the glass substrate 101 and color filters CF of three types are stacked in the limited black matrix BM area. On the lamination of the color filters CF of the three types, a transparent conductive film 107 is formed. On the upper surface of the transparent conductive film 107, a resin layer 109 made of the same material as the projection MVA is stacked to increase the height of the columnar member PL. The resin layer 109 is continuous, in the area outside the columnar member PL, with the projection MVA for orientating liquid crystal molecules.

The thin film transistor substrate and color filter substrate are faced each other and the columnar members PL are abutted on the cross points between the gate bus lines GB and data bus lines DB to thereby define the distance between both the substrates. It is not easy, however, to maintain flatness of the surfaces of both the substrates at abutting points and therefore to maintain the gaps between the substrates uniform.

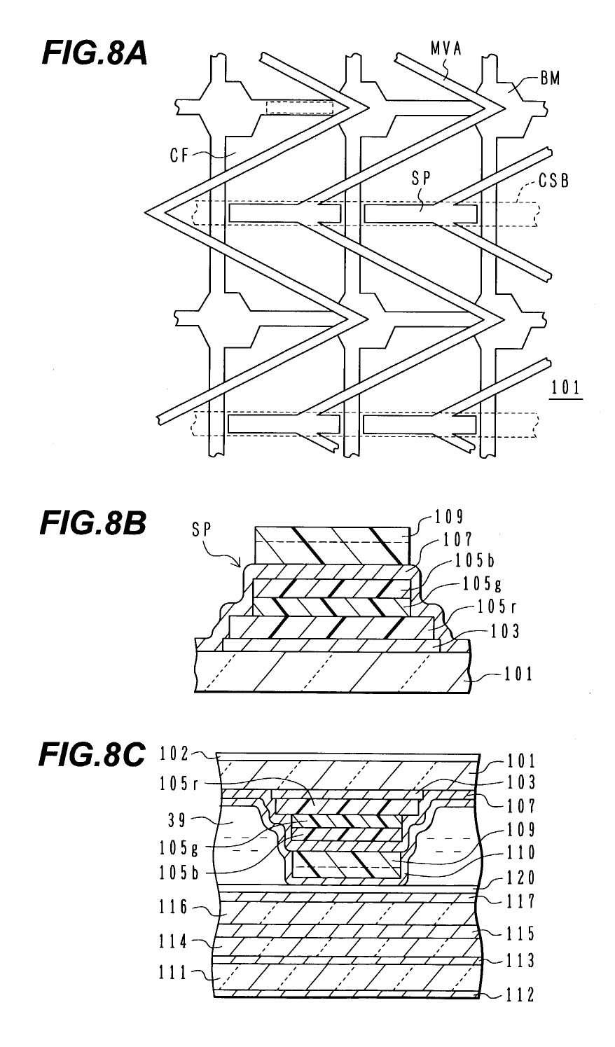

FIGS. 8A, 8B and 8C illustrate the improvement on the previous proposal shown in FIGS. 12A, 12B and 12C. The structure of a thin film transistor matrix is similar to the previous proposal and is not shown in the drawings. As shown in FIG. 8A, in a color filter substrate, a black matrix BM is formed on a glass substrate 101. After a color filter CF corresponding to each pixel area is formed, a transparent conductive film is formed on the whole surface of the substrate to form a multi domain projection MVA. An extended spacer member SP extending in an extension direction of a storage capacitor electrode CSB is formed in an area above the storage capacitor electrode CSB.

The extended spacer member has a length in the extension direction longer than the length (width) in the lateral direction by a twofold or more. With this structure, the upper surface of the spacer member is made broad and flatness can be easily realized.

FIG. 8B is a cross sectional view showing the structure of the spacer member SP. On the surface of a glass substrate 101, a Cr film 103 used as the black matrix is patterned in the shape of the spacer member SP. On the light shielding film 103, color filter layers 105r, 105g and 105b of three types are stacked. On the color filter layers of the three types, one layer is continuous with the adjacent color filter CF. A transparent conductive film 107 is formed covering the color filter layers. On the transparent conductive film 107, a resist layer 109 made of resist or the like continuous with the projection MVA is formed. The thickness of the projection MVA is determined in accordance with the application field thereof. If the height of the spacer member SP is insufficient, a resin layer for the spacer member SP may be stacked further as indicated by a broken line.

In this manner, the spacer member SP extending in the area above the storage capacitor electrode is formed.

FIG. 8C shows the structure of a thin film transistor substrate and color filter substrate facing each other and squeezing a liquid crystal layer therebetween. The color filter substrate has the glass substrate 101 on which the above-described structure is formed. On this structure, an alignment film 110 is formed. A polarizer 102 is formed on the opposite surface of the glass substrate 101.

The thin film transistor substrate has a glass substrate 111 on which a storage capacitor electrode 113, a gate insulating film 114, an intermediate conductor 115, a protective film 116 and a transparent conductive film 117 are stacked. On this structure, an alignment film 120 is formed. A polarizer 112 is formed on the bottom of the glass substrate 111. The alignment films 110 and 120 of both the substrates are in surface contact with each other to define a gap between both the substrates. A liquid crystal layer 39 is squeezed in the gap between both the substrates. Since the spacer member SP has a broad area extending in the extension direction of the storage capacitor electrode, the upper surface of the spacer member can be easily planarized and the gap between both the substrates can be easily made uniform.

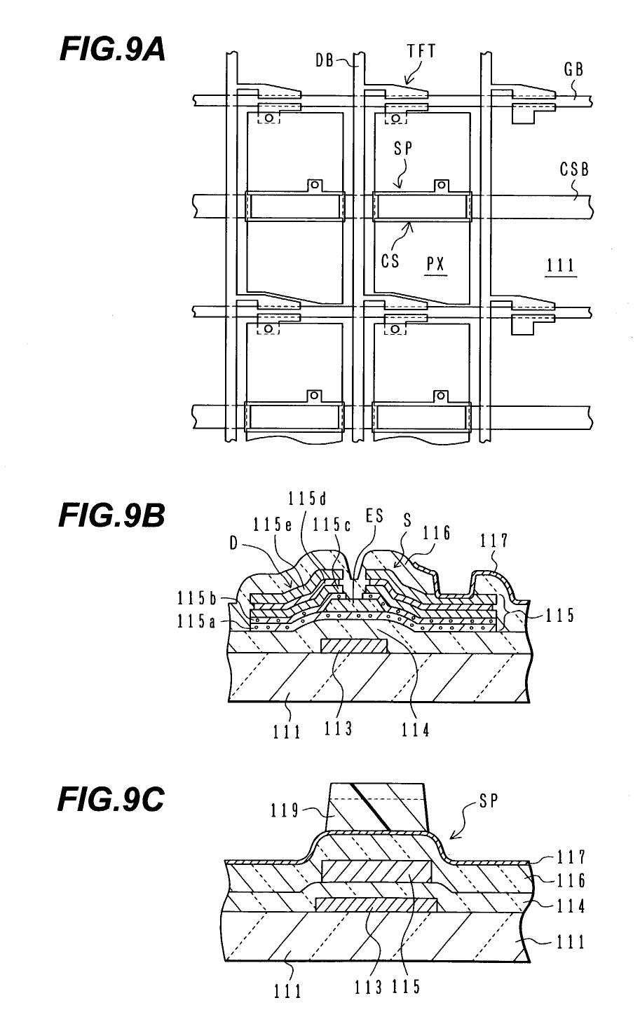

FIGS. 9A, 9B and 9C show the structure of a spacer member SP formed on the storage capacitor electrode of a thin film transistor substrate in place of the color filter substrate.

As shown in FIG. 9A, on a glass substrate 111, a light shielding metal film such as a Cr film is patterned, the metal film forming gate bus lines GB and storage capacitor electrodes CSB. A gate insulating film is formed on the metal layer, and on the gate insulating film, a lamination of semiconductor layers and metal layers is deposited to form drain bus lines DB and functional layers of thin film transistors TFT. At the same time, the structure up to an intermediate electrode is formed above the storage capacitor electrode CSB. On this structure, a protective layer and a transparent conductive layer are stacked. After the storage capacitor CS is formed in the above manner, a resin layer is stacked to form a spacer member SP.

FIG. 9B is a cross sectional view showing the structure of a thin film transistor. On a glass substrate 111, a gate bus line 113 is patterned and a gate insulating film 114 is formed covering the gate bus line 113. On the gate insulating film 114, a high resistance semiconductor layer 115a, a low-resistance semiconductor layer 115b, a Ti layer 115c, an Al layer 115d and a Ti layer 115e are stacked to form a thin film transistor.

An etching stopper layer ES is formed above the channel region. A protective film 116 is formed covering the thin film transistor. After a contact hole is formed through the protective film 116, a transparent conductive film 117 is formed. Instead of a single metal layer, the metal layer 113 of the gate electrode may be made of a lamination of a Ti layer and an Al layer, or the like.

FIG. 9C is a cross sectional view showing the structure of the spacer member. A lamination of a glass substrate 111, a metal layer 113, a gate insulating film 114, a conductive layer 115, a protective layer 116 and a transparent conductive film 117 has the same structure as that of the thin film transistor region. On the transparent conductive film 117, a resin layer 119 is deposited. If a projection for multi domains is formed as described earlier, the resin layer 119 may be made of the same material as the projection. In this case, if the height is insufficient, a resin layer may be stacked further.

By using the thin film transistor substrate formed in the above manner and a color filter substrate having the same structure as that of the color filer substrate previously proposed, a liquid crystal display device can be structured. Since the spacer member SP has an elongated shape extended in the extension direction of the storage capacitor electrode, the upper surface of the spacer member SP can be easily planarized and the gap between both the substrates can be easily made uniform.

The position where the spacer member SP is formed is not limited only to the area extending along the extension direction of the storage capacitor electrode. The space member SP may be formed superposed upon the bus line and extending in the extension direction of the bus line.

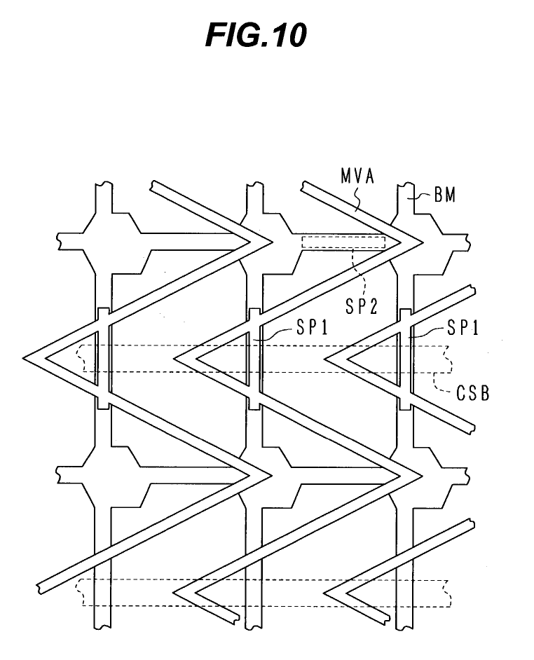

FIG. 10 shows the structure of a spacer member formed in an area corresponding to the bus line of a color filter substrate. The black matrix BM of the color filter substrate has a shape corresponding to the gate bus line and data bus line. A spacer member SP1 is formed on an area corresponding to the data bus line, and a spacer member SP2 is formed on a black matrix area corresponding to the gate bus line. Either the spacer member SP1 or the spacer member SP2 is formed.

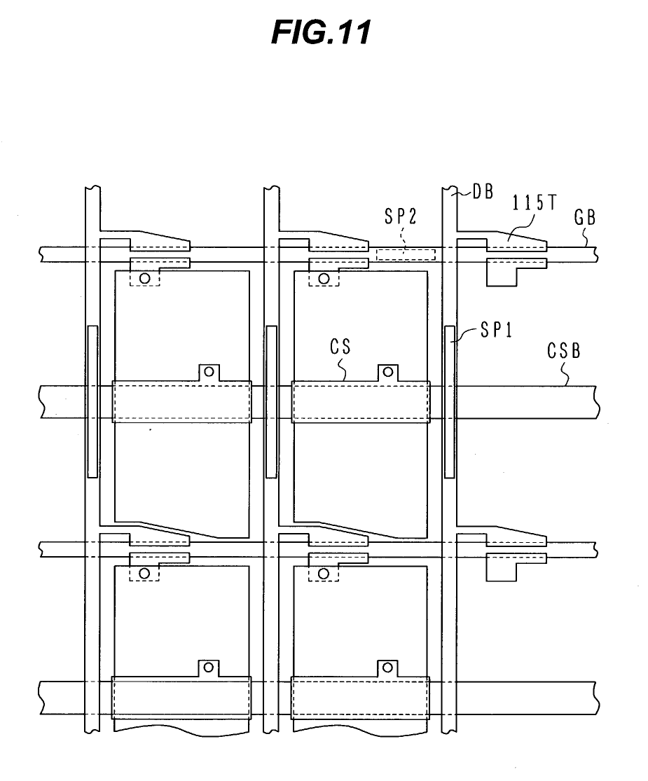

FIG. 11 shows the structure of a spacer member formed on a thin film transistor substrate. A spacer member SP1 is formed above a data bus line DB, and a spacer member SP2 is formed above a gate bus line GB. Either the spacer member SP1 or the spacer member SP2 is formed.

With each of the above-described structures, an area where the spacer member is formed can be made broad. It is preferable to set the length of the spacer member in the extension direction at least a twofold or more of the shorter side length, and more preferable to set the length a threefold or more.

The present invention has been described in connection with the preferred embodiments. The invention is not limited only to the above embodiments. It is apparent that various modifications, improvements, combinations, and the like can be made by those skilled in the art.

What we claim are:

1. A method of manufacturing a display device comprising steps of:
(a) capturing an insulating granular spacer with an optical forceps apparatus which utilizes a capture force of a laser beam;
(b) disposing the insulating granular spacer captured with the optical forceps apparatus on one of a pair of display device substrates at a predetermined position; and
(c) stacking the pair of display device substrates via the insulating granular spacer.

2. A method according to claim 1, wherein the optical forceps apparatus uses a first laser beam propagating along a first direction and a second laser beam propagating along a second direction crossing the first direction and captures the insulating granular spacer at a cross point of the first and second laser beams.

3. A method according to claim 1, further comprising a step of:
(d) coating adhesive on the insulating granular spacer captured with the optical forceps apparatus between said steps (a) and (b).

4. A method according to claim 1, wherein in said step (a) the optical forceps apparatus uses a plurality of first laser beams to capture a plurality of insulating granular spacers floating in liquid, and in said step (b) the optical forceps apparatus disposes at the same time the plurality of insulating granular spacers on one of the pair of display device substrates at a plurality of positions having a predetermined positional relation.

5. A method according to claim 4, wherein the plurality of first laser beams propagate along a first direction and converge upon a first plane crossing the first direction, and the optical forceps apparatus uses a second laser beam propagating along a second direction in the first plane and captures the insulating granular spacer at a cross point of the first and second laser beams.

6. A display device comprising:
a first substrate having a plurality of pixel areas each including a display area and including a pixel electrode and a pixel electrode driving element, and groups of crossed signal lines for transmitting signals for driving each pixel electrode driving element;
a second substrate disposed facing said first substrate, said second substrate including a light transmitting area including a color filter corresponding to each display area and a light shielding area other than the light transmitting area;
a plurality of insulating granular spacers disposed between said first and second substrates and aligned generally with the light shielding area, said insulating granular spacers defining a distance between the first and second substrates; and
a liquid crystal layer filled in a space between said first and second substrates.

7. A method of manufacturing a liquid crystal display device with a step of dumping a foreign matter in a liquid crystal display panel, the panel comprising:
a thin film transistor substrate including a first transparent substrate, a plurality of gate bus lines juxtaposed on the first transparent substrate, a plurality of data bus lines juxtaposed along a direction crossing the gate bus lines, a thin film transistor connected at each cross point between the gate bus line and data bus line, and a pixel electrode connected to each thin film transistor;
an opposing substrate disposed facing the thin film transistor substrate, the opposing substrate including a second transparent substrate and a common electrode formed on the second transparent substrate; and
a liquid crystal layer squeezed between the thin film transistor substrate and the opposing substrate,
and the method comprising steps of:
(a) capturing a foreign matter between the substrates by applying a capture laser beam to the foreign matter or destroying the foreign matter by applying a destruction laser beam to the foreign matter and thereafter capturing the destroyed foreign matter by applying the capture laser beam to the destroyed foreign matter; and
(b) controlling a relative position between the capture laser beam and the liquid crystal display panel and dumping the captured foreign matter in a collection area other than a predetermined area.

8. A method according to claim 7, wherein the destruction laser beam and the capture laser beam are irradiated from different laser sources.

9. A method according to claim 7, wherein the predetermined area is an image display area and the collection area is an area covered with a light shielding film.

10. A method of manufacturing a liquid crystal display device, the liquid crystal display device comprising:
a thin film transistor substrate including a first transparent substrate, a plurality of gate bus lines juxtaposed on the first transparent substrate, a plurality of data bus lines juxtaposed along a direction crossing the gate bus lines, a thin film transistor connected at each cross point between the gate bus line and data bus line, and a pixel electrode connected to each thin film transistor;
an opposing substrate disposed facing the thin film transistor substrate, the opposing substrate including a second transparent substrate and a common electrode formed on the second transparent substrate; and
a liquid crystal layer squeezed between the thin film transistor substrate and the opposing substrate,
and the method comprising steps of:
(a) preparing the thin film transistor substrate and the opposing substrate;
(b) capturing a foreign matter on at least one of the substrates by applying a capture laser beam to the foreign matter or destroying the foreign matter by applying a destruction laser beam to the foreign matter and thereafter capturing the destroyed foreign matter by applying the capture laser beam to the destroyed foreign matter;
(c) controlling a relative position between the capture laser beam and one of the substrates and dumping the captured foreign matter in an area outside said at least one substrate; and
(d) bonding together said thin film transistor substrate and the opposing substrate opposing each other.

11. A liquid crystal display device comprising:
a thin film transistor substrate including a first transparent substrate formed with a plurality of gate bus lines juxtaposed on the first transparent substrate, a plurality of data bus lines juxtaposed along a direction crossing the gate bus lines, a thin film transistor connected at each cross point between the gate bus line and data bus line, and a pixel electrode connected to each thin film transistor;
an opposing substrate disposed facing the thin film transistor substrate, the opposing substrate including a second transparent substrate formed with a common electrode;
a liquid crystal layer squeezed between said thin film transistor substrate and said opposing substrate; and
a foreign matter collected in a collection area other than a predetermined area in a space between said thin film transistor substrate and said opposing substrate.

12. A liquid crystal display device according to claim 11, wherein the predetermined area is an image display area and the collection area is an area covered with a light shielding film.

13. A liquid crystal display device comprising:
a thin film transistor substrate including a first transparent substrate formed with a plurality of gate bus lines juxtaposed on the first transparent substrate, a plurality of data bus lines juxtaposed along a direction crossing the gate bus lines, a thin film transistor connected at each cross point between the gate bus line and data bus line, a transparent pixel electrode connected to each thin film transistor and including a display area, and a storage capacitor electrode facing each transparent pixel electrode via an insulating layer and extending along each transparent pixel electrode;
a color filter substrate disposed facing said thin film transistor substrate, said color filter substrate including a second transparent substrate formed with a light shielding film defining an area corresponding to each display area, a light transmitting area defined by the light shielding film, corresponding to each display area and including a color filter, and a common transparent electrode disposed on the color filters; and
a plurality of extended spacer members extending above at least one of the gate bus lines, data bus lines and storage capacitor electrodes along an extension direction thereof, said extended spacer members defining a distance between said thin film transistor substrate and said color filter substrate.

14. A liquid crystal display device according to claim 13, wherein said extended spacer member is formed on said color filter substrate and includes a lamination of a plurality of layers made of the same layers as the color filters and another resin layer.

15. A method of manufacturing a liquid crystal display device comprising steps of:
(a) manufacturing a first substrate including a first transparent substrate formed with a plurality of gate bus lines juxtaposed on the first transparent substrate, a plurality of data bus lines juxtaposed along a direction crossing the gate bus lines, a thin film transistor connected at each cross point between the gate bus line and data bus line, a transparent pixel electrode connected to each thin film transistor and including a display area, and a storage capacitor electrode facing each transparent pixel electrode via an insulating layer and extending along each transparent pixel electrode;
(b) manufacturing a second substrate including a second transparent substrate formed with a light shielding film defining an area corresponding to each display area, a light transmitting area defined by the light shielding film, corresponding to each display area and including a color filter, a common transparent electrode disposed on the color filters, and a plurality of extended spacer members extending above at least one of the gate bus lines, data bus lines and storage capacitor electrodes along an extension direction thereof, said extended spacer member being disposed superposed upon the light shielding film and including a lamination of a plurality of layers made of the same layers as the color filters and another resin layer; and
(c) disposing said first and second substrates facing each other via said plurality of extended spacer members.

16. A method of manufacturing a liquid crystal display device comprising steps of:
(a) manufacturing a first substrate including a first transparent substrate formed with a plurality of gate bus lines juxtaposed on the first transparent substrate, a plurality of data bus lines juxtaposed along a direction crossing the gate bus lines, a thin film transistor connected at each cross point between the gate bus line and data bus line, a transparent pixel electrode connected to each thin film transistor and including a display area, a storage capacitor electrode facing each transparent pixel electrode via an insulating layer and extending along each transparent pixel electrode, and a plurality of extended spacer members extending above at least one of the gate bus lines, data bus lines and storage capacitor electrodes along an extension direction thereof;
(b) manufacturing a second substrate including a second transparent substrate formed with a light shielding film defining an area corresponding to each display area, a light transmitting area defined by the light shielding film, corresponding to each display area and including a color filter, and a common transparent electrode disposed on the color filters; and
(c) disposing said first and second substrates facing each other via said plurality of extended spacer members.
